(19) United States
(12) Patent Application Publication
(10) Pub. No.: US 2012/0323639 A1
(43) Pub. Date: Dec. 20, 2012

(54) SYSTEM AND METHOD FOR DETERMINING MATURITY LEVELS FOR BUSINESS PROCESSES

(75) Inventors: Navin Sabharwal, New Delhi (IN); Prafull Verma, Cary, NC (US); Vijayakumar Chinnaswamy, Noida (IN); Tajeshwar Singh, Noida (IN); B Kalyan Kumar, Noida (IN); Anubhav Saxena, San Jose, CA (US); Shashibhan Singh, Kanpur (IN); Aushdeep Gupta, Ghaziabad (IN); Srikrishna Ramakarthikeyan, Flemington, NJ (US); Renju George Varghese, Noida (IN)

(73) Assignee: HCL AMERICA INC., SUNNYVALE, CA (US)

(21) Appl. No.: 13/162,083

(22) Filed: Jun. 16, 2011

(51) Int. Cl. G06Q 10/00

(52) U.S. Cl. 705/7.38

(57) ABSTRACT

A system, computer-readable storage medium, and computer-implemented method for determining a maturity level for a business process. Responses to questions relating to a business process for a business are received. A first business process maturity level is determined using the responses to the questions. Performance statistics are obtained from a database including historical data related to the business process. A second business process maturity level is determined using the performance statistics. A weight factor is determined using the first business process maturity level and the second business process maturity level, the weight factor corresponding to a correlation between the first business process maturity level and the second business process maturity level. A weighted business process maturity level is calculated for the business process using the first business process maturity level and the weight factor. The weighted business process maturity level for the business process is stored in the database.

### TECHNICAL FIELD

The disclosed embodiments relate generally to determining maturity levels for business processes.

### BACKGROUND

As a business develops and matures, its business processes evolve to provide improved products and/or services. For example, a new business that provides technical support for computer systems may receive an issue reported by a user and manually assign a technical support representative to handle the issue. In contrast, a mature business that provides technical support for computer systems may proactively detect the issue and automatically assign a technical support representative to handle the issue. Typically, the maturity levels of business processes increase over time as the business gains knowledge, technology, personnel, and/or customers. Thus, as a business evolves to meet market demand, it is desirable for the business to identify the scope of possible improvements to business processes and to leverage new technology and new knowledge in a structured and timely manner.

### BRIEF DESCRIPTION OF THE DRAWINGS

FIG. 1 is a block diagram illustrating modules for determining maturity levels for business processes of a business, according to some embodiments.

FIG. 2 is a block diagram illustrating modules for determining maturity levels for business processes, determining recommended actions, and auditing the business processes, according to some embodiments.

FIG. 3 is a block diagram illustrating modules of a computer system, according to some embodiments.

FIG. 4 is a flowchart of a method for determining a maturity level for a business process, according to some embodiments.

FIG. 5 is a flowchart of a method for updating performance statistics in a database, determining trends in the business process using the performance statistics, and generating a report of the trends in the business process, according to some embodiments.

FIG. 6 is a flowchart of a method for determining recommended actions, updating performance statistics for the business process, and generating a progress report, according to some embodiments.

FIG. 7 is a flowchart of a method for determining recommended actions using a weighted business process maturity level, according to some embodiments.

FIG. 8 is a flowchart of a method for determining a compliance level for a business process, generating recommended actions, and generating a progress report, according to some embodiments.

FIG. 9 is a flowchart of a method for determining recommended actions using a compliance level and a weighted business process maturity level, according to some embodiments.

FIG. 10 is a block diagram of a machine, according to some embodiments.

Like reference numerals refer to corresponding parts throughout the drawings.

### DESCRIPTION OF EMBODIMENTS

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

The embodiments described herein provide techniques for determining maturity levels for processes. The maturity levels for the processes may be used to audit the processes (e.g., compare the processes with standardized processes) and/or may be used to track the development of the processes. In some embodiments, the processes are business processes.

The term “process” as used herein comprises a series of activities to produce a product or perform a service, and is to be interpreted broadly as including a process group, a sub-process, or any collection of processes. Therefore, the totality of activities and/or processes which may be performed in an enterprise may also be referred to as a process.

The term “data” as used herein refers to any information items that a process may depend upon or utilize and is to be interpreted broadly as including master data, reference data, transaction data, event data, analytical data, meta-data, text or binary content, and the like.

A process may include a sequence in which activities of the process are performed, rules determining subsequent activities to be performed, service-level agreements (SLAs), key performance indicators (KPIs), and the like. A process may also include data such as human resource roles for performing respective activities, information technology (IT) systems supporting respective activities, data dependency information regarding respective activities, data input information indicating expected inputs, which may be associated with particular process activities and/or process participants, physical infrastructure associated with respective activities, such as vehicles, machinery, and the like, and other elements associated with the process.

“Process element” means any element of a process, including IT hardware, IT applications, human resource components, datastores, physical elements, events, and the like.

Note that although the embodiments discussed herein refer to business processes of a business, the embodiments discussed herein may be applied to any process. Furthermore, note that in embodiments referring to a business performing actions, the actions may be performed by representatives of the business (e.g., owners, employees, contractors, etc.).

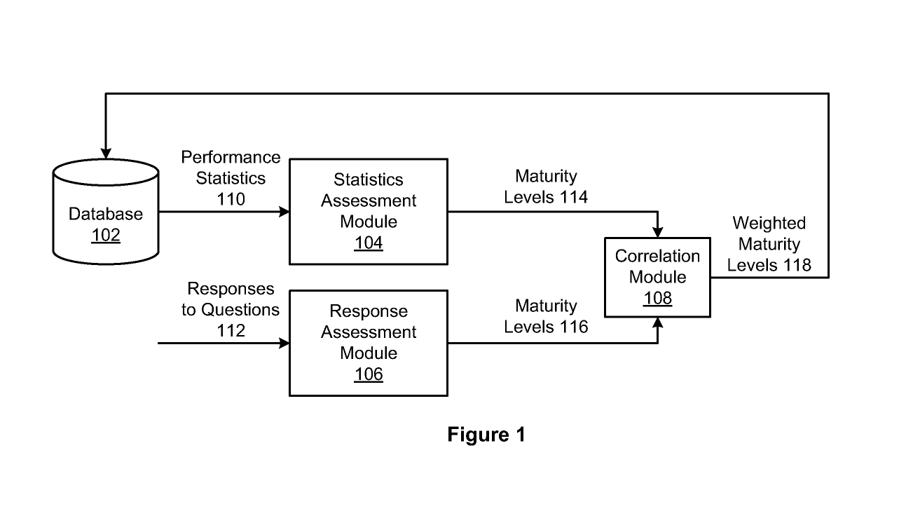

FIG. 1 is a block diagram illustrating modules for determining maturity levels for business processes of a business, according to some embodiments. A statistics assessment module 104 obtains performance statistics 110 for business processes of a business from a database 102. In some embodiments, the database 102 includes a plurality of databases. In some embodiments, the plurality of databases is distributed across a plurality of physical locations (e.g., buildings, geographic regions, etc.). The statistics assessment module 104 then uses the performance statistics 110 to determine maturity levels 114 of business processes of the business. In some embodiments, multiple performance statistics may be associated with a business process. For example, statistics relating to SLA adherence, the time taken to resolve incidents, and an incident backlog may be associated with an incident resolution process that manages the resolution of incident tickets. In some embodiments, a single performance statistic may be associated with multiple business processes. For example, statistics relating to time taken to resolve incidents may be associated with both an incident resolution process that manages the resolution of incident tickets and an incident prevention process that proactively detects and corrects issues in a product or service prior to an incident occurring (e.g., a failure in the product or service).

Note that a maturity level of a business process may be based on factors such as the manner in which the business handles a particular issue, a level of efficiency with which the business executes the business process (e.g., the time to handle an issue), and an extent to which the business process is integrated with hardware and/or software that increases the efficiency of the business process. For example, consider a business process that is related to the manner in which infrastructure incidents are detected and recorded by a business. A high maturity level for this business process may indicate that the business has integrated tools that proactively detect issues encountered by customers and that monitor the progress of resolving the issues. In contrast, a low maturity level for this business process may indicate that the business reactively handles issues as customers report them and the issues are entered manually into the tools that monitor the progress of resolving the issues.

In some embodiments, a maturity level of a business process is defined by the business (or by representatives of the business). In some embodiments, the maturity level of a business process is defined by a standards organization (e.g., the International Organization for Standardization (ISO)).

A response assessment module 106 obtains responses to questions 112 and uses the responses to questions 112 to determine maturity levels 114 of business processes of the business. In some embodiments, the responses to questions 112 are received from a computer system for the business. In some embodiments, multiple questions (and corresponding responses to these questions) may be associated with a business process. In some embodiments, a single question (and corresponding response to the question) may be associated with multiple business processes.

A correlation module 108 uses the maturity levels 114 and the maturity levels 116 to determine weight factors to be applied to the maturity levels 116, which are then used to calculate weighted maturity levels 118 for the business processes. In some embodiments, the weighted maturity levels 118 are stored in the database 102. In some embodiments, the values of the weight factors are user-configurable. For example, the values of the weight factors may be specified by the business. Alternatively, the values of the weight factors may be specified by a standards organization such as the ISO.

The performance statistics 110 are objective metrics that measure the performance of the business processes. In some embodiments, the performance statistics include one or more of: customer satisfaction scores, SLAadherence statistics, an incidence backlog, time taken to resolve incidents, and a number of reopened incidents. Customer satisfaction scores may include statistics relating to scores given by customers of the business in response to a customer satisfaction survey designed to rate the services or products of the business. SLA adherence statistics may include statistics (e.g., minimum uptime, maximum downtime, response times to reported incidents, time to resolve customer issues, etc.) that indicate the level to which business has adhered to SLA with customers. An incidence backlog may include statistics relating to an average (e.g., over a given time period, etc.), peak, and/or a current number of incidents that have been logged but have not been resolved. A number of reopened incidents may include statistics relating to an average (e.g., over a given time period, etc.) and/or a total number of reopened incidents. Note that other performance statistics that provide objective metrics that measure the performance of the business may also be obtained and used.

The following example is provided to facilitate understanding of the process of determining maturity levels of business processes of a business discussed above. Assume that the business process being evaluated is the manner in which infrastructure incidents are detected and recorded by a business. Also assume that there are five maturity levels for this business process. In this example, the statistics assessment module 104 may obtain performance statistics 110 including response times of the business for handling infrastructure incidents (e.g., SLA adherence statistics). The response times may be mapped to the maturity levels as illustrated in Table 1.

TABLE 1
Maturity Levels vs. Response times

| Level | Response Time | |
|---|---|---|
| 1 | >30 | minutes |
| 2 | 15 to 30 | minutes |
| 3 | 10 to 15 | minutes |
| 4 | 5 to 10 | minutes |
| 5 | <10 | minutes |

In this example, the statistics assessment module 104 determines that the maturity level 114 of this business process is Level 3.

Continuing the example, the response assessment module 106 may obtain responses to the following question posed to the business: “How are infrastructure incidents detected and recorded?” The question posed to the business may include five predetermined responses that the business may choose, where each response corresponds to a maturity level as illustrated in Table 2.

TABLE 2
Maturity Levels vs. Questionnaire Responses

| Level | Questionnaire Answer |
|---|---|
| 1 | Infrastructure incidents are detected most of the time |
| | through customer calls, email, etc. Formal tools for |
| | detection and recording do not exist. |
| 2 | Infrastructure incidents are detected and recorded in an |
| | IT service management (ITSM) system or other |
| | automated event management system. Manual |
| | intervention may be used to record incidents into the |
| | system. |
| 3 | Fully-automated incident detection and recording |
| | mechanism with complete two way integration between |
| | an event management system and an incident |
| | management system. |
| 4 | Incidents are detected and recorded and information |
| | related to incidents including configuration item (CI) |
| | enrichment, prioritization, and assignment are fully- |
| | automated. |
| 5 | Incidents are detected proactively and logged. A high |
| | level of integration with problem management, a |
| | configuration management database (CMDB), and |
| | knowledge management processes allow the business to |
| | identify related incidents and problems. |

In this example, the response assessment module 106 determines that the maturity level 116 for this business process is Level 1.

The correlation module 108 then determines weight factors to apply to the maturity level 116 using the maturity levels 114 and 116. In some embodiments, a weight factor applied to a maturity level 116 corresponds to a correlation between the maturity level 114 and the maturity level 116. For example, when the maturity level 116 is level 1, the weights illustrated in Table 3 may be applied to the maturity level 116 based on the maturity level 114:

TABLE 3
Weight Factors

| Maturity Level 114 | Maturity Level 116 | Weight Factor |
|---|---|---|
| 1 | 1 | 1.0 |
| 2 | 1 | 0.8 |
| 3 | 1 | 0.6 |
| 4 | 1 | 0.4 |
| 5 | 1 | 0.2 |

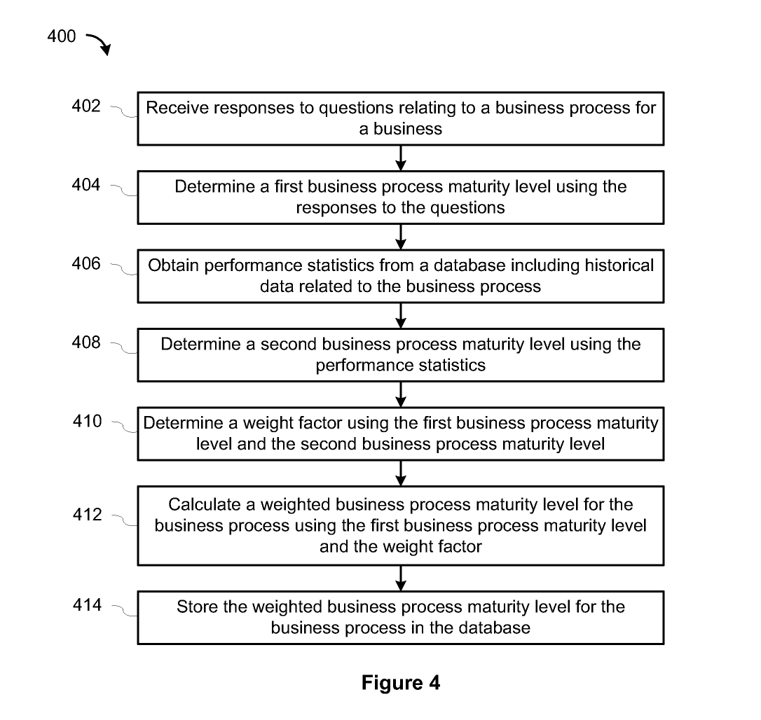

As illustrated in this example, the closer the correlation between the maturity level 114 and the maturity level 116, the higher the weight factor that is applied to the maturity level 116. Note that the values of the weight factors may be assigned in any manner (e.g., linear distribution, non-linear distribution, etc.). Also note that similar weight factors may be applied to other levels. For example, when the maturity level 116 is level 3, the weights illustrated in FIG. 4 may be applied to the maturity level 116 based on the maturity level 114:

TABLE 4
Weight Factors

| Maturity Level 114 | Maturity Level 116 | Weight Factor |
|---|---|---|
| 1 | 3 | 0.6 |
| 2 | 3 | 0.8 |
| 3 | 3 | 1.0 |
| 4 | 3 | 0.8 |
| 5 | 3 | 0.6 |

Note that Level 2 and Level 4 are only one level from Level 3. Thus, in this example, Level 2 and Level 4 receive the same weight. In other words, the weight factor may be assigned based on the magnitude of the difference between the maturity level and a maturity level in which the maturity level 114 and maturity level 116 are the same level. This magnitude of the difference may be referred to as a “distance” from a point of correlation. Note that, in general, the weight factors for levels that are the same distance away from a point of correlation do not need to be the same value. For example, it may be desirable to underestimate the maturity level of a business process rather than overestimate the maturity level of a business process. Thus, in the example illustrated in Table 4, the weight factor for Level 2 may be set to 0.8 while the weight factor for Level 4 may be set to 0.7. Again, the values of the weight factors may be assigned in any manner (e.g., linear distribution, non-linear distribution, etc.).

To complete the example, since the maturity level 116 indicates that the business process is at Level 1 and the maturity level 114 indicates that the business process is at Level 3, the correlation module 108 applies the weight 0.6 to the maturity level 116.

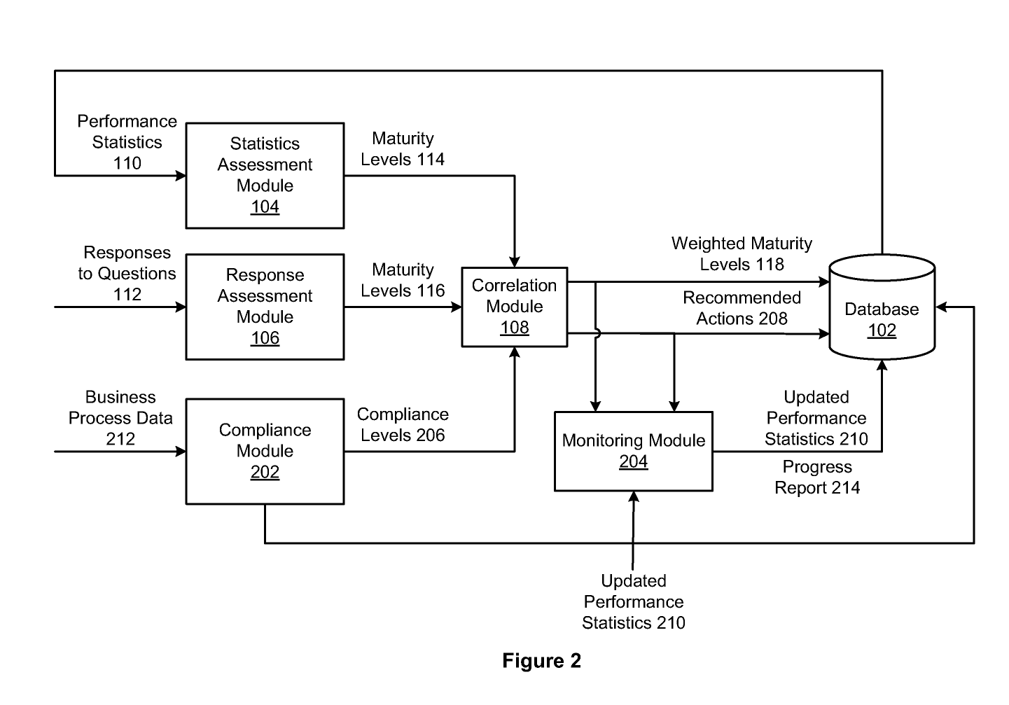

Attention is now directed to FIG. 2, which is a block diagram illustrating modules for determining maturity levels for business processes, determining recommended actions, and auditing the business processes, according to some embodiments. The modules illustrated in FIG. 2 are similar to the modules illustrated in FIG. 1. Therefore, only the differences are discussed.

In some embodiments, after the correlation module 108 calculates the weighted maturity levels 118, the correlation module 108 determines recommended actions using the weighted maturity levels 118. For example, consider a business process that is associated with five questions and corresponding responses to questions 112. The weighted maturity levels 118 corresponding to the five responses to questions 112 may indicate a number of recommended actions 208 for improving the business process. Continuing the example from above, the recommended actions 208 may be actions that the business may perform to improve the manner in which infrastructure incidents are detected and recorded by a business. For example, the recommended actions 208 may suggest that the business implement new hardware and/or software systems to improve the manner in which infrastructure incidents are detected and recorded by the business.

In some embodiments, for each business process, the weighted maturity levels 118 for the business process may be combined to generate a composite maturity level. For example, assume that the business process is associated with five questions and corresponding responses to questions 112. The weighted maturity levels 118 corresponding to the five responses to questions 112 may then be averaged together to produce the composite maturity level for the business process. The composite maturity level is then used to determine the recommended actions to improve the business process. Note that other techniques for generating a composite maturity level may be used.

In some embodiments, the weighted maturity levels 118 for the business process indicate the probability that the business process is at particular maturity levels. For example, assume that maturity level 116 is Level 4 and has a weight factor of 0.8. In this example, the maturity level 116 may be interpreted as having an 80% chance of being a Level 4 maturity level.

In some embodiments, the recommended actions 208 are stored in the database 102.

In some embodiments, a monitoring module 204 periodically receives updated performance statistics 210 for business processes of a business. In some embodiments, the updated performance statistics 210 are stored in the database 102

In some embodiments, the monitoring module 204 uses the updated performance statistics 210 to generate a progress report 214 indicating changes in the maturity level of the business processes subsequent to the implementation of the recommended actions 208. In some embodiments, the progress report 214 is stored in the database 102.

In some embodiments, a compliance module 202 receives business process data 212 and determines compliance levels 206 of the business processes of the business with respect to a standardized business process (e.g., an ISO standardized business process). In some embodiments, the business process data 212 includes responses to questions 112 and responses to a checklist based on a standardized business process (e.g., an ISO standard). In some embodiments, the compliance module 202 stores the compliance levels 206 in the database 102. In some embodiments, the correlation module 108 determines recommended actions 208 using the compliance levels 206 and the weighted maturity levels 118.

In some embodiments, a progress report includes color-coded indicators that correspond to the progress that the business has made with respect to implementing the recommended actions. For example, recommended actions color-coded red may indicate that the recommended actions have been delayed and/or have not been implemented at all, recommended actions color-coded yellow may indicate that the recommended actions are still in the process of being implemented and/or that there are marginal delays, and recommended actions color-coded green may indicate that the action has been successfully implemented on time.

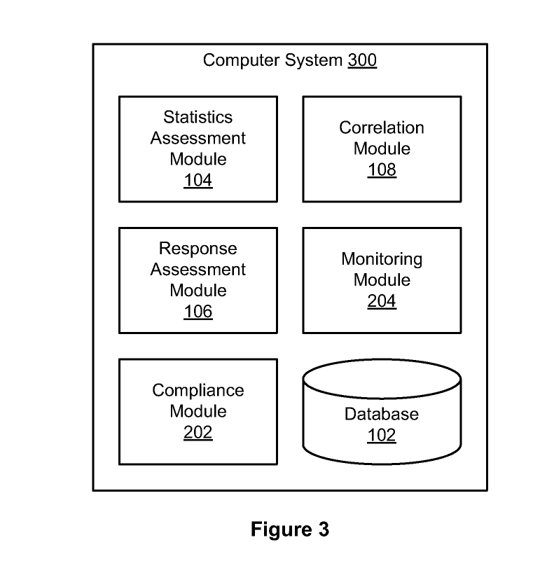

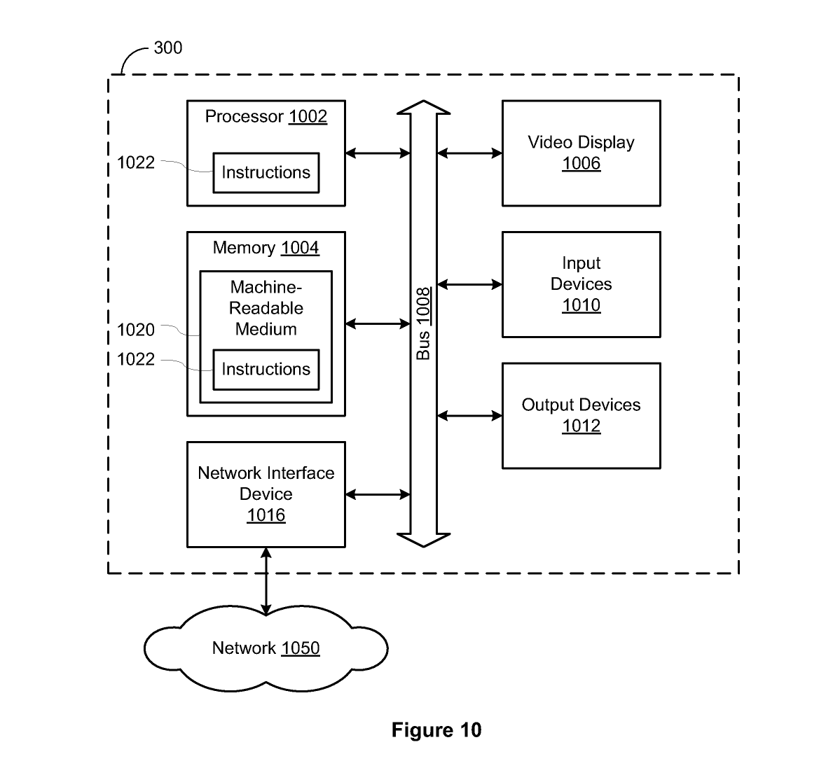

FIG. 3 is a block diagram illustrating modules of a computer system 300, according to some embodiments. The computer system 300 includes the statistics assessment module 104, the response assessment module 106, the correlation module 108, and the database 102. In some embodiments, the computer system 300 also includes the monitoring module 204. In some embodiments, the computer system 300 also includes the compliance module 202. An exemplary implementation of the computer system 300 is described in more detail with respect to FIG. 10 below.

The processes discussed above are described in more detail with respect to FIGS. 4-9 below. Although FIGS. 4-9 refer to a single business process of a business, the techniques described with respect to FIGS. 4-9 may be applied to multiple business processes of the business.

FIG. 4 is a flowchart of a method 400 for determining a maturity level for a business process, according to some embodiments. The response assessment module 106 receives (402) responses to questions relating to a business process for a business and determines (404) a first business process maturity level using the responses to the questions. The statistics assessment module 104 obtains (406) performance statistics from the database 102, which includes historical data related to the business process, and determines (408) a second business process maturity level using the performance statistics. The correlation module 108 determines (410) a weight factor using the first business process maturity level and the second business process maturity level. In some embodiments, the weight factor corresponds to a correlation between the first business process maturity level and the second business process maturity level. The correlation module 108 then calculates (412) a weighted business process maturity level for the business process using the first business process maturity level and the weight factor and stores (414) the weighted business process maturity level for the business process in the database 102.

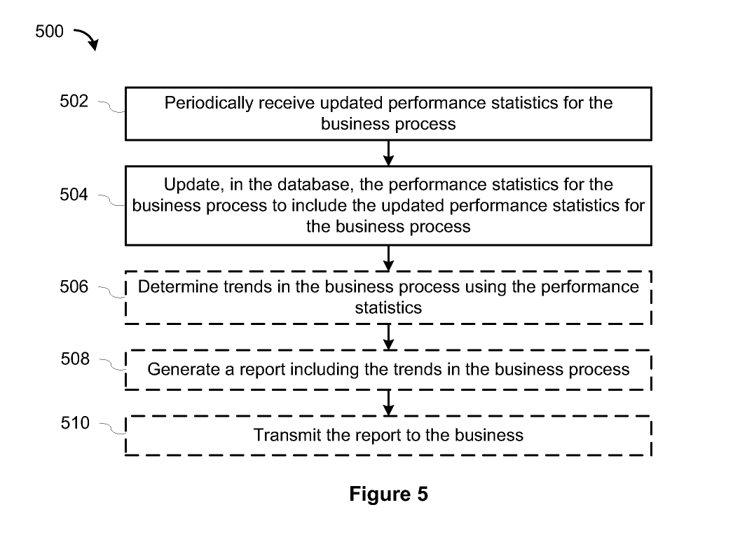

As a business develops and evolves, it is desirable to periodically monitor the business processes. Thus, in some embodiments, performance statistics of the business process for the business are periodically updated. FIG. 5 is a flowchart of a method 500 for updating performance statistics in a database, determining trends in the business process using the performance statistics, and generating a report of the trends in the business process, according to some embodiments. The monitoring module 204 periodically receives (502) updated performance statistics for the business process and updates (504), in the database 102, the performance statistics for the business process to include the updated performance statistics for the business process.

In some embodiments, the monitoring module 204 determines (506) trends in the business process using the performance statistics, generates (508) a report including the trends in the business process, and transmits (510) the report to the business.

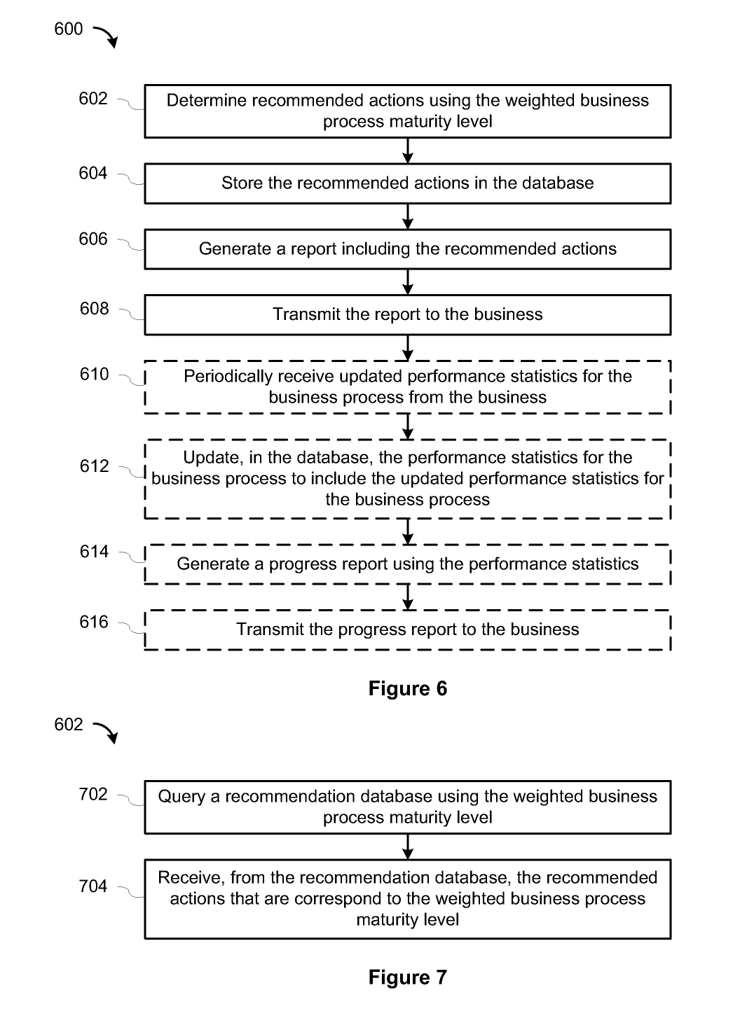

As discussed above, after determining maturity levels of a business process, it is often desirable to determine recommended actions that the business may take in order to improve the business process. FIG. 6 is a flowchart of a method 600 for determining recommended actions, updating performance statistics for the business process, and generating a progress report, according to some embodiments. The correlation module 108 determines (602) recommended actions using the weighted business process maturity level. In some embodiments, the recommended actions include actions to be taken by the business to improve the business process. Attention is now directed to FIG. 7, which is a flowchart of a method for determining (602) recommended actions using a weighted business process maturity level, according to some embodiments. The correlation module 108 queries (702) a recommendation database using the weighted business process maturity level. In some embodiments, the recommendation database includes recommended actions indexed by weighted process maturity levels. In some embodiments, the database 102 includes the recommendation database. The correlation module then receives (704), from the recommendation database, the recommended actions that correspond to the weighted business process maturity level.

Returning to FIG. 6, the correlation module 108 stores (604) the recommended actions in the database 102. The correlation module 108 then generates (606) a report including the recommended actions and transmits (608) the report to the business.

After a business implements the recommended actions, it is desirable to monitor progress of the recommended actions. In some embodiments, the monitoring module 204 periodically receives (610) updated performance statistics for the business process from the business and updates (612), in the database 102, the performance statistics for the business process to include the updated performance statistics for the business process. The monitoring module 204 then generates (614) a progress report using the performance statistics and transmits (616) the progress report to the business. In some embodiments, the progress report indicates changes in the maturity level of the business process subsequent to the implementation of the recommended actions.

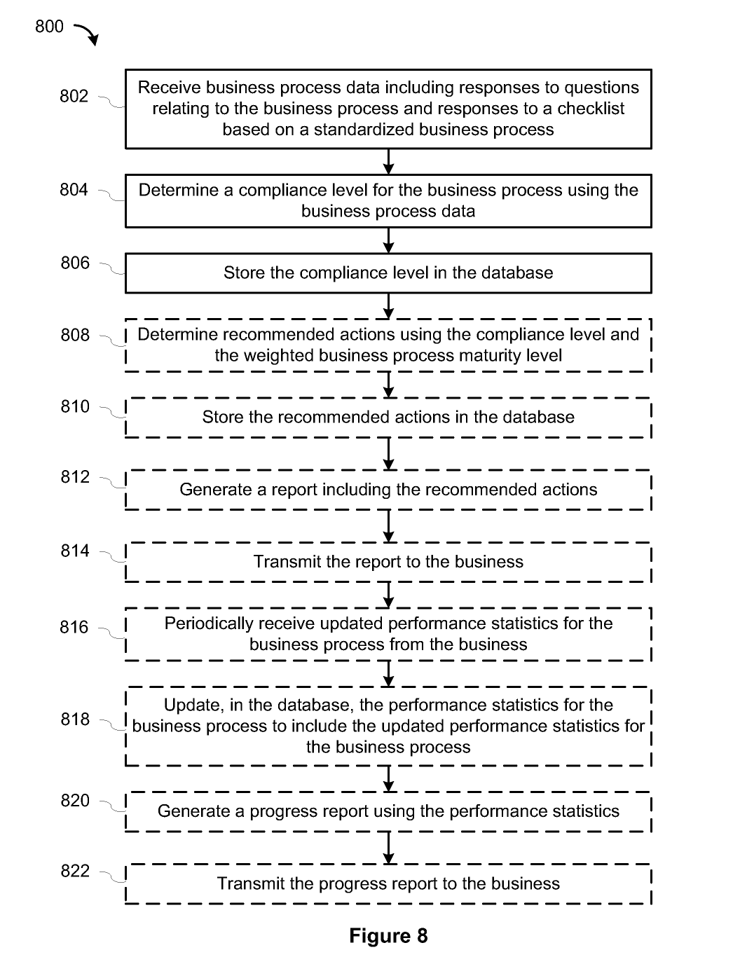

It is often desirable to compare the business processes of the business against standardized business processes (e.g., as defined by the ISO) to gauge the level at which the business processes of the business complies with standardized business processes. FIG. 8 is a flowchart of a method 800 for determining a compliance level for a business process, generating recommended actions, and generating a progress report, according to some embodiments. The compliance module 202 receives (802) business process data including responses to questions relating to the business process and responses to a checklist based on a standardized business process. The compliance module 202 determines (804) a compliance level for the business process using the business process data. In some embodiments, the compliance level corresponds to a level at which the business process complies with the standardized business process. The compliance module 202 then stores (806) the compliance level in the database.

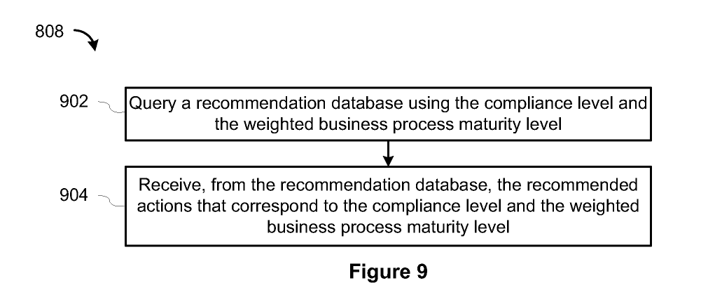

After determining the compliance level for the business process, it may be desirable to determine recommended actions that the business may implement to bring the business process into compliance with a standardized business process. Thus, in some embodiments, the correlation module 108 determines (808) recommended actions using the compliance level and the weighted business process maturity level. In some embodiments, the correlation module 108 queries the recommendation database to obtain recommended actions based on the compliance level and the weighted business process maturity level. Attention is now directed to FIG. 9, which is a flowchart of a method for determining (808) recommended actions using a compliance level and a weighted business process maturity level, according to some embodiments. The correlation module 108 queries (902) a recommendation database using the compliance level and the weighted business process maturity level. In some embodiments, the recommendation database includes recommended actions indexed by compliance levels and weighted process maturity levels. In some embodiments, the database 102 includes the recommendation database. The correlation module 108 then receives (904), from the recommendation database, the recommended actions that correspond to the compliance level and the weighted business process maturity level.

Returning to FIG. 8, the correlation module 108 then stores (810) the recommended actions in the database and generates (812) a report including the recommended actions and transmits (814) the report to the business.

After the business starts implementing the recommended actions, it may be desirable to monitor the effect of the recommended actions on the business process. In some embodiments, the monitoring module 204 periodically receives (816) updated performance statistics for the business process from the business and updates (818), in the database 102, the performance statistics for the business process to include the updated performance statistics for the business process. In other words, the updated performance statistics are combined with (e.g., appended to, averaged into, etc.) the performance statistics already stored in the database 102. The monitoring module 204 then generates (820) a progress report using the performance statistics. In some embodiments, the progress report indicates changes in the compliance level of the business process subsequent to the implementation of the recommended actions. The monitoring module 204 then transmits (822) the progress report to the business.

FIG. 10 depicts a block diagram of a machine in the example form of a computer system 300 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computer system 300 includes a processor 1002 (e.g., a central processing unit (CPU), a graphics processing unit (GPU) or both), and memory 1004, which communicate with each other via bus 1008. Memory 1004 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 1004 may optionally include one or more storage devices remotely located from the computer system 300. The computer system 300 may further include a video display unit 1006 (e.g., a plasma display, a liquid crystal display (LCD) or a cathode ray tube (CRT)). The computer system 300 also includes input devices 1010 (e.g., keyboard, mouse, trackball, touchscreen display, etc.), output devices 1012 (e.g., speakers), and a network interface device 1016. The aforementioned components of the computer system 300 may be located within a single housing or case (e.g., as depicted by the dashed lines in FIG. 10). Alternatively, a subset of the components may be located outside of the housing. For example, the video display unit 1006, the input devices 1010, and the output device 1012 may exist outside of the housing, but be coupled to the bus 1008 via external ports or connectors accessible on the outside of the housing.

Memory 1004 includes a machine-readable medium 1020 on which is stored one or more sets of data structures and instructions 1022 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 1022 may also reside, completely or at least partially, within memory 1004 and/or within the processor 1002 during execution thereof by computer system 300, with memory 1004 and processor 1002 also constituting machine-readable, tangible media.

The data structures and instructions 1022 may further be transmitted or received over a network 1050 via network interface device 1016 utilizing any one of a number of well-known transfer protocols (e.g., HyperText Transfer Protocol (HTTP)). Network 1050 can generally include any type of wired or wireless communication channel capable of coupling together computing nodes (e.g., the computer system 300). This includes, but is not limited to, a local area network (LAN), a wide area network (WAN), or a combination of networks. In some embodiments, network 1050 includes the Internet.

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 300) or one or more hardware modules of a computer system (e.g., a processor 1002 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 1002 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 1002 configured using software, the general-purpose processor 1002 may be configured as respective different hardware modules at different times. Software may accordingly configure a processor 1002, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1002 that are temporarily configured (e.g., by software, code, and/or instructions stored in a machine-readable medium) or permanently configured to perform the relevant operations. Whether temporarily or permanently configured, such processors 1002 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1002 or processor-implemented (or computer-implemented) modules. Similarly, at least some of the operations of a method may be governed by instructions that are stored in a computer readable storage medium and executed by one or more processors 1002 or processor-implemented (or computer-implemented) modules. The performance of certain of the operations may be distributed among the one or more processors 1002, not only residing within a single machine, but deployed across a number of machines. In some example embodiments, the processors 1002 may be located in a single location (e.g., within a home environment, an office environment or as a server farm), while in other embodiments the processors 1002 may be distributed across a number of locations.

While the embodiment(s) is (are) described with reference to various implementations and exploitations, it will be understood that these embodiments are illustrative and that the scope of the embodiment(s) is not limited to them. In general, techniques for the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

What is claimed is:

1. A computer-implemented method for determining a maturity level for a business process, the method comprising:
using at least one processor of a computer system to execute instructions stored in memory of the computer system to perform the operations of:
receiving responses to questions relating to a business process for a business;
determining a first business process maturity level using the responses to the questions;
obtaining performance statistics from a database including historical data related to the business process;
determining a second business process maturity level using the performance statistics;
determining a weight factor using the first business process maturity level and the second business process maturity level, the weight factor corresponding to a correlation between the first business process maturity level and the second business process maturity level;
calculating a weighted business process maturity level for the business process using the first business process maturity level and the weight factor; and
storing the weighted business process maturity level for the business process in the database.

2. The computer-implemented method of claim 1, further comprising:
periodically receiving updated performance statistics for the business process; and
updating, in the database, the performance statistics for the business process to include the updated performance statistics for the business process.

3. The computer-implemented method of claim 2, further comprising:
determining trends in the business process using the performance statistics;
generating a report including the trends in the business process; and
transmitting the report to the business.

4. The computer-implemented method of claim 1, further comprising:
determining recommended actions using the weighted business process maturity level, the recommended actions including actions to be taken by the business to improve the business process;
storing the recommended actions in the database;
generating a report including the recommended actions; and
transmitting the report to the business.

5. The computer-implemented method of claim 4, wherein determining the recommended actions using the weighted business process maturity level includes:
querying a recommendation database using the weighted business process maturity level, the recommendation database including recommended actions indexed by weighted process maturity levels;
receiving, from the recommendation database, the recommended actions that correspond to the weighted business process maturity level.

6. The computer-implemented method of claim 4, further comprising:
periodically receiving updated performance statistics for the business process from the business;
updating, in the database, the performance statistics for the business process to include the updated performance statistics for the business process;
generating a progress report using the performance statistics, the progress report indicating changes in the maturity level of the business process after the business started implementing the recommended actions; and
transmitting the progress report to the business.

7. The computer-implemented method of claim 1, further comprising:
receiving business process data including responses to questions relating to the business process and responses to a checklist based on a standardized business process;
determining a compliance level for the business process using the business process data, the compliance level corresponding to a level at which the business process complies with the standardized business process; and
storing the compliance level in the database.

8. The computer-implemented method of claim 7, further comprising:
determining recommended actions using the compliance level and the weighted business process maturity level, the recommended actions including actions to be taken by the business to improve the business process;
storing the recommended actions in the database;
generating a report including the recommended actions; and
transmitting the report to the business.

9. The computer-implemented method of claim 8, wherein determining the recommended actions using the compliance level and the weighted business process maturity level includes:
querying a recommendation database using the compliance level and the weighted business process maturity level, the recommendation database including recommended actions indexed by compliance levels and weighted process maturity levels;
receiving, from the recommendation database, the recommended actions that correspond to the compliance level and the weighted business process maturity level.

10. The computer-implemented method of claim 8, further comprising:
periodically receiving updated performance statistics for the business process from the business;
updating, in the database, the performance statistics for the business process to include the updated performance statistics for the business process;
generating a progress report using the performance statistics, the progress report indicating changes in the compliance level of the business process subsequent to the implementation of the recommended actions; and
transmitting the progress report to the business.

11. The computer-implemented method of claim 1, wherein the responses to questions relating to the business process for the business are received from a computer system for the business.

12. The computer-implemented method of claim 1, wherein the performance statistics include one or more of:
customer satisfaction scores;
service level agreement (SLA) adherence statistics;
an incidence backlog;
time taken to resolve incidents; and
a number of reopened incidents.

13. A system to determine a maturity level for a business process, comprising:
at least one processor;
memory; and
at least one program stored in the memory, the at least one program comprising instructions to:
receive responses to questions relating to a business process for a business;
determine a first business process maturity level using the responses to the questions;
obtain performance statistics from a database including historical data related to the business process;
determine a second business process maturity level using the performance statistics;
determine a weight factor using the first business process maturity level and the second business process maturity level, the weight factor corresponding to a correlation between the first business process maturity level and the second business process maturity level;
calculate a weighted business process maturity level for the business process using the first business process maturity level and the weight factor; and
store the weighted business process maturity level for the business process in the database.

14. The system of claim 13, further comprising instructions to:
periodically receive updated performance statistics for the business process; and
update, in the database, the performance statistics for the business process to include the updated performance statistics for the business process.

15. The system of claim 14, further comprising instructions to:
determine trends in the business process using the performance statistics;
generate a report including the trends in the business process; and
transmit the report to the business.

16. The system of claim 13, further comprising instructions to:
determine recommended actions using the weighted business process maturity level, the recommended actions including actions to be taken by the business to improve the business process;
store the recommended actions in the database;
generate a report including the recommended actions; and
transmit the report to the business.

17. The system of claim 16, wherein the instructions to determine the recommended actions using the weighted business process maturity level include instructions to:
query a recommendation database using the weighted business process maturity level, the recommendation database including recommended actions indexed by weighted process maturity levels;
receive, from the recommendation database, the recommended actions that correspond to the weighted business process maturity level.

18. The system of claim 16, further comprising instructions to:
periodically receive updated performance statistics for the business process from the business;
update, in the database, the performance statistics for the business process to include the updated performance statistics for the business process;
generate a progress report using the performance statistics, the progress report indicating changes in the maturity level of the business process subsequent to the implementation of the recommended actions; and
transmit the progress report to the business.

19. A computer readable storage medium storing at least one program configured for execution by a computer, the at least one program comprising instructions to:
receive responses to questions relating to a business process for a business;
determine a first business process maturity level using the responses to the questions;
obtain performance statistics from a database including historical data related to the business process;
determine a second business process maturity level using the performance statistics;
determine a weight factor using the first business process maturity level and the second business process maturity level, the weight factor corresponding to a correlation between the first business process maturity level and the second business process maturity level;
calculate a weighted business process maturity level for the business process using the first business process maturity level and the weight factor; and
store the weighted business process maturity level for the business process in the database.

20. The computer readable storage medium of claim 19, further comprising instructions to:
periodically receive updated performance statistics for the business process; and
update, in the database, the performance statistics for the business process to include the updated performance statistics for the business process.
